(19) United States
(12) Patent Application Publication
(10) Pub. No.: US 2014/0018977 A1
(43) Pub. Date: Jan. 16, 2014

(54) AUTOMOBILE CONTROL METHOD

(71) Applicant: HON HAI PRECISION INDUSTRY CO., LTD., New Taipei (TW)

(72) Inventors: CHUNG-I LEE, New Taipei (TW); CHUN-MING CHEN, New Taipei (TW)

(21) Appl. No.: 13/933,404

(22) Filed: Jul. 2, 2013

(30) Foreign Application Priority Data
Jul. 11, 2012 (TW) 101124893

(51) Int. Cl. G06F 17/00

(52) U.S. Cl. CPC G06F 17/00
USPC 701/2

(57) ABSTRACT

In an automobile control method, verification means are set to control access to the automobile, and criterions of the verification means are stored. A network connection between the automobile and an electronic device is established to send a verification message to the electronic device according to the verification means and to receive verification information from the electronic device. The received verification information is compared with the criterions of the verification means. When the received verification information matches the criterions of the verification means, the automobile can be controlled by the electronic device.

### BACKGROUND

1. Technical Field

Embodiments of the present disclosure relate to automobile control systems and methods, more particularly to an automobile and a control method of the automobile.

2. Description of Related Art

A car key, or an automobile key, is used to open or start an automobile, or both. Usually, the car key has multiple uses for the automobile. The car key can open the doors of the automobile, as well as start the ignition, open the glove compartment, open the trunk of the automobile, and so on.

However, car keys are easy to be lost or stolen, causing inconvenience for drivers of the automobiles.

### BRIEF DESCRIPTION OF THE DRAWINGS

FIG. 1 is a block diagram of one embodiment of an automobile with an automobile control system installed.

FIG. 2 illustrates a flowchart of one embodiment of an automobile control method.

FIG. 3 illustrates a flowchart of one embodiment of a method for generating verification information by an electronic device.

### DETAILED DESCRIPTION

In general, the word “module,” as used herein, refers to logic embodied in hardware, firmware, or to a collection of software instructions written in a programming language such as Java, C, or assembly. One or more software instructions in the modules may be embedded in firmware, such as in an EPROM. The modules described herein may be implemented as software and/or hardware modules and may be stored in any type of non-transitory computer-readable medium or other storage device. Some non-limiting examples of non-transitory computer-readable media include CDs, DVDs, BLU-RAY, flash memory, and hard disk drives.

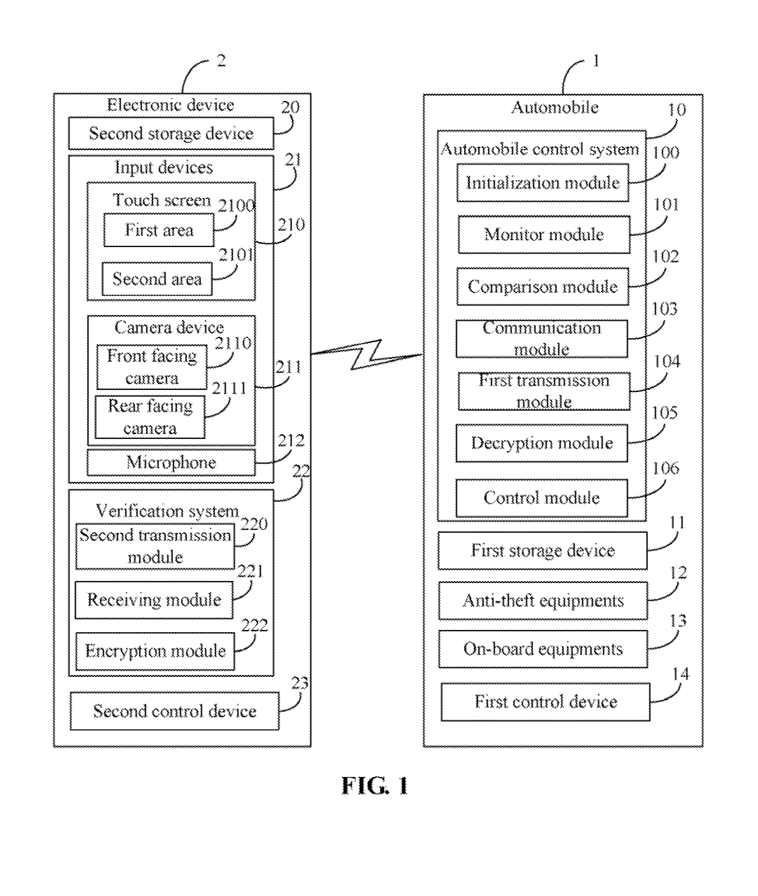

FIG. 1 is a block diagram of one embodiment of an automobile 1 with an automobile control system 10 installed. The automobile 1 includes, but is not limited to, a first storage device 11, one or more anti-theft equipments 12, one or more on-board equipments 13, and a first control device 14.

The automobile control system 10 includes a plurality of function modules, which include computerized code when executed to provide an automobile control method to control the automobile 1, such as unlocking the anti-theft equipments 12 and starting the on-board equipments 13.

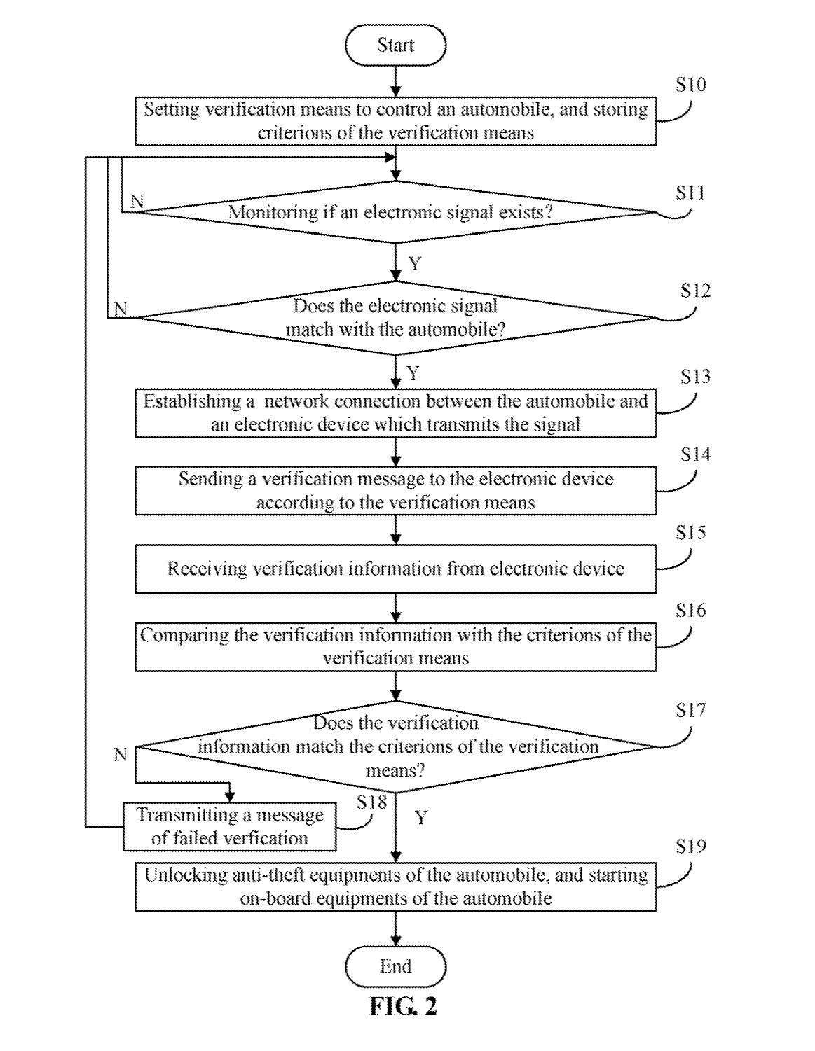

The plurality of function modules includes an initialization module 100, a monitor module 101, a comparison module 102, a communication module 103, a first transmission module 104, a decryption module 105, and a control module 106. The detailed functions of the function modules 100-106 are illustrated in FIG. 2.

The first storage device 11 may include any type(s) of non-transitory computer-readable storage medium, such as a hard disk drive, a compact disc, a digital video disc, or a tape drive. The first storage device 11 stores the computerized codes of the function modules of the automobile control system 10.

The anti-theft equipments 12 may include, but are not limited to, the doors, the ignition system, and the steering wheel of the automobile 1. The on-board equipments 13 may include, but are not limited to, a Global Positioning System (GPS), an Event Data Recorder (EDR), an automobile audio system, and a computer.

The first control device 14 may be a processor, a microprocessor, an application-specific integrated circuit (ASIC), or a field programmable gate array (FPGA), for example. The first control device 14 executes the computerized codes of the function modules of the automobile control system 10.

The automobile 1 communicates with an electronic device 2 to receive verification information that is used to control the automobile 1. In one embodiment, the communication between the automobile 1 and the electronic device 2 is a wireless connection using BLUETOOTH technology, WIFI technology, ZigBee technology, or Radio Frequency Identification (RFID) technology. In another embodiment, the communication between the automobile 1 and the electronic device 2 is a wired connection using a USB interface.

The electronic device 2 may be a smart phone, a tablet personal computer, or a personal digital assistant (PDA), for example. The electronic device 2 includes, but is not limited to, a second storage device 20, one or more input devices 21, a verification system 22, and a second control device 23.

The second storage device 20 may include any type(s) of non-transitory computer-readable storage medium, such as a hard disk drive, a compact disc, a digital video disc, or a tape drive.

The second control device 23 may be a processor, a microprocessor, an application-specific integrated circuit (ASIC), or a field programmable gate array (FPGA), for example.

Each of the input devices 21 may include a touch screen 210, a camera device 211, and/or a microphone 212. The touch screen 210 may include a first area 2100 and a second area 2101. The first area 2100 provides a blank area where a signature is drawn using a finger or a stylus. The second area 2101 provides a list of alphabetic and numeric characters to input a password. The camera device 211 includes a front facing camera 2110 and a rear facing camera 2111. In one embodiment, the rear facing camera 2111 has a higher resolution than that of the front facing camera 2110.

The verification system 22 includes a plurality of function modules, which include computerized codes when executed to receive the verification information and transmit the verification information to the automobile control system 10 to control the automobile 1. The computerized codes are stored in the second storage device 20 and are executed by the second control device 23.

In one embodiment, the verification information includes a signature received from the first area 2100 of the touch screen 210, a password received from the second area 2101 of the touch screen 210, a face image received from the front facing camera 2110 of the camera device 211, a fingerprint image received from the rear facing camera 2111 of the camera device 211, and/or a voice print received from the microphone 212.

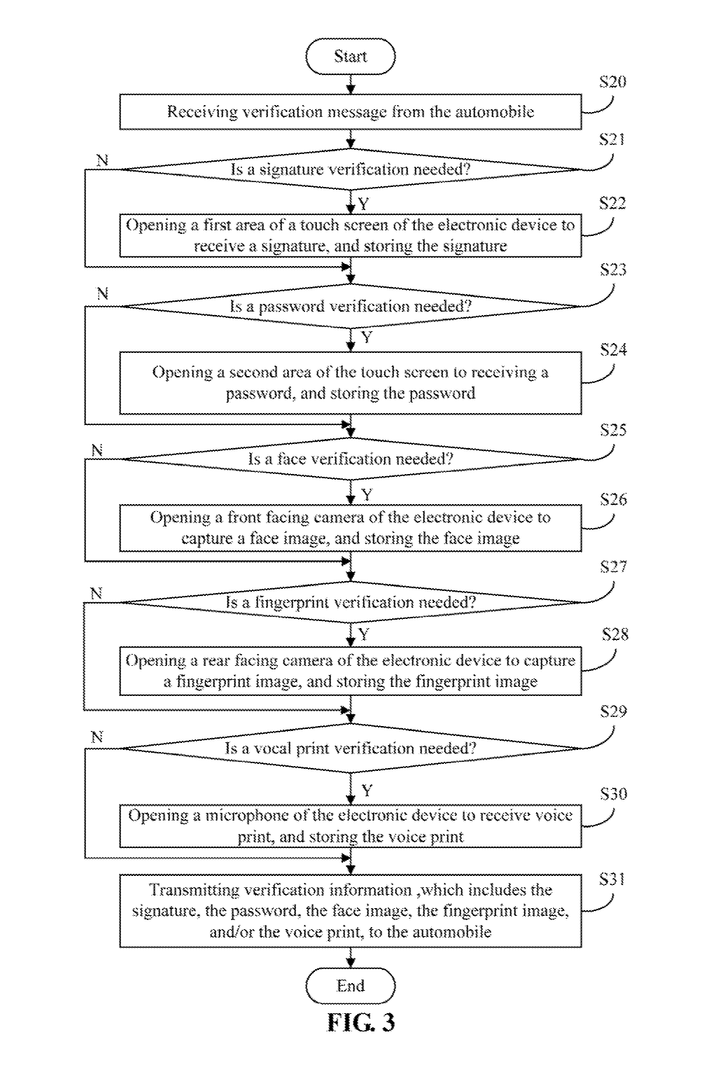

The plurality of function modules of the verification system 22 may include a second transmission module 220, a receiving module 221, and an encryption module 222. The detailed functions of the function modules 220-222 are illustrated in FIG. 3.

FIG. 2 illustrates a flowchart of one embodiment of an automobile control method of the automobile 1. Depending on the embodiment, additional steps may be added, others removed, and the ordering of the steps may be changed.

In step S10, the initialization module 100 sets verification means to control the automobile 1 and stores criterions of the verification means. The verification means include a signature verification, a password verification, a face verification, a fingerprint verification, and/or a vocal print verification. The criterions of the verification means include a reference signature, a reference password, a reference face image, a reference fingerprint image, and/or a reference voice print. The criterions of the verification means are stored in the first storage device 11 of the automobile 1.

In step S11, the monitor module 101 monitors whether or not an electronic signal exists within a predetermined range of the automobile 1. As mentioned above, the electronic device 2 communicates with the automobile 1 using WiFi or Bluetooth, etc. In one embodiment, the electronic device 2 transmits a continuous specific electronic signal. When the electronic device 2 enters within the predetermined range of the automobile 1, the monitor module 101 detects the signal, and step S12 is implemented. Otherwise, if no electronic signal is detected, step S11 is repeated.

In step S12, the comparison module 102 determines whether or not the electronic signal matches with the automobile 1. The electronic signal transmitted by the electronic device 2 has a particular code. The particular code is unique in identifying the electronic device 2. For example, the particular code may be the serial number of the electronic device.

In one embodiment, the comparison module 102 compares the particular code received from the electronic device 2 with one or more reference codes stored in the first storage device 11 of the automobile 1. If the particular code of the electronic device 2 matches one of the reference codes stored in the first storage device 11, the comparison module 102 determines that the electronic signal matches with the automobile 1, and step S13 is implemented. Otherwise, if the particular code of the electronic device 2 does not match with any reference code stored in the first storage device 11, the comparison module 102 determines that the electronic signal does not match with the automobile 1, and the process goes back to step S11. In one embodiment, the reference codes stored in the first storage device 11 of the automobile 1 can be edited using the initialization module 100.

In step S13, the communication module 103 establishes a network connection between the automobile 1 and the electronic device 2 using BLUETOOTH technology, WIFI technology, ZigBee technology, or RFID technology, for example.

In step S14, the first transmission module 104 sends a verification message to the electronic device 2 according to the verification means. For example, if the verification means includes a signature verification, the verification message will say, “please sign your name.” If the verification means includes a password verification, the verification message will say, “please input a password.” The verification message is shown on the touch screen 210 of the electronic device 2.

In step S15, the first transmission module 104 receives verification information from the electronic device 2. The verification information may include a signature, a password, a face image, a fingerprint image, and/or a voice print. If the received verification information is encrypted, in step S15, the decryption module 105 decrypts the verification information received from the electronic device 2.

In step S16, the comparison module 102 compares the received verification information with the criterions of the verification means, and in step S17, the comparison module 102 determines whether or not the received verification information matches the criterions of the verification means. If the received verification information does not match the criterions of the verification means, step S18 is implemented. Otherwise, if the received verification information matches the criterions of the verification means, step S19 is implemented.

In step S18, the first transmission module 104 transmits a message of failed verification, or in step S19, the control module 106 receives a control operation signal from the electronic device 2 and controls the automobile 1 to perform the control operation. The control operation may include unlocking the anti-theft equipments 12 or starting the on-board equipments 13.

FIG. 3 illustrates a flowchart of one embodiment of a method for generating the verification information by the electronic device 2. Depending on the embodiment, additional steps may be added, others removed, and the ordering of the steps may be changed.

In step S20, the second transmission module 220 receives the verification message from the automobile 1.

In step S21, the receiving module 221 determines whether or not a signature verification is needed according to the verification message. Step S22 is implemented if a signature verification is needed. Otherwise, step S23 is directly implemented if a signature verification is not needed.

In step S22, the receiving module 221 opens the first area 2100 of the touch screen 210 to receive a signature and stores the signature in the second storage device 20 of the electronic device 2.

In step S23, the receiving module 221 determines whether or not a password verification is needed according to the verification message. Step S24 is implemented if a password verification is needed. Otherwise, step S25 is directly implemented if a password verification is not needed.

In step S24, the receiving module 221 opens the second area 2101 of the touch screen 210 to receive a password and stores the password in the second storage device 20 of the electronic device 2.

In step S25, the receiving module 221 determines whether or not a face verification is needed according to the verification message. Step S26 is implemented if a face verification is needed. Otherwise, step S27 is directly implemented if a face verification is not needed.

In step S26, the receiving module 221 opens the front facing camera 2110 of the camera device 211 to capture a face image and stores the face image in the second storage device 20 of the electronic device 2.

In step S27, the receiving module 221 determines whether or not a fingerprint verification is needed according to the verification message. Step S28 is implemented if a fingerprint verification is needed. Otherwise, step S29 is directly implemented if a fingerprint verification is not needed.

In step S28, the receiving module 221 opens the rear facing camera 2111 of the camera device 211 to capture a fingerprint image and stores the fingerprint image in the second storage device 20 of the electronic device 2.

In step S29, the receiving module 221 determines whether or not a vocal print verification is needed according to the verification message. Step S30 is implemented if a vocal print verification is needed. Otherwise, step S31 is directly implemented if a vocal print verification is not needed.

In step S30, the receiving module 221 opens the microphone 212 to receive a voice print and stores the voice print into the second storage device 20 of the electronic device 2.

In step S31, the second transmission module 220 transmits the verification information, which includes the signature, the password, the face image, the fingerprint image, and/or the voice print to the automobile 1. In one embodiment, in step S31, before transmitting the verification information, the encryption module 222 encrypts the verification information.

It should be emphasized that the above-described embodiments of the present disclosure, particularly, any embodiments, are merely possible examples of implementations merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and are protected by the following claims:

What is claimed is:

1. An automobile control method being performed by execution of computerized codes by at least one processor, the method comprising:
setting verification means to control an automobile, and storing criterions of the verification means;
establishing a communication between the automobile and an electronic device, and sending a verification message to the electronic device according to the verification means;
receiving verification information from the electronic device, and comparing the received verification information with the criterions of the verification means; and
receiving a control operation from the electronic device upon condition that the received verification information matches with the criterions of the verification mean, and controlling the automobile to perform the control operation.

2. The method according to claim 1, wherein the verification means comprise a signature verification, a password verification, a face verification, a fingerprint verification, and/or a vocal print verification, and the criterions of the verification means comprise a reference signature, a reference password, a reference face image, a reference fingerprint image, and/or a reference voice print.

3. The method according to claim 1, before establishing a communication between the automobile and an electronic device, the method further comprising:
monitoring whether or not an electronic signal exists within a predetermined range of the automobile;
determining whether or not the electronic signal matches with the automobile, and establishing the communication between the automobile and the electronic device which transmits the electronic signal.

4. The method according to claim 3, wherein the electronic signal transmitted by the electronic device has a particular code, and when the particular code of the electronic device matches with one or more reference codes stored in a storage device of the automobile, the electronic signal is determined to match with the automobile.

5. The method according to claim 1, wherein the verification information comprises a signature, a password, a face image, a fingerprint image, and/or a voice print.

6. The method according to claim 1, wherein the control operation comprises unlocking one or more anti-theft equipments of the automobile and starting one or more on-board equipments of the automobile.

7. An automobile, comprising:
a control device;
a storage device storing one or more programs which when executed by the control device, causes the control device to:
set verification means to control an automobile, and store criterions of the verification means;
establish a communication between the automobile and an electronic device, and send a verification message to the electronic device according to the verification means;
receive verification information from the electronic device, and compare the received verification information with the criterions of the verification means; and
receive a control operation from the electronic device upon condition that the received verification information matches with the criterions of the verification mean, and control the automobile to perform the control operation.

8. The automobile according to claim 7, wherein the verification means comprise a signature verification, a password verification, a face verification, a fingerprint verification, and/or a vocal print verification, and the criterions of the verification means comprise a reference signature, a reference password, a reference face image, a reference fingerprint image, and/or a reference voice print.

9. The automobile according to claim 7, before establishing a communication between the automobile and an electronic device, the control device further:
monitors whether or not an electronic signal exists within a predetermined range of the automobile; and
establishes the communication between the automobile and the electronic device which transmits the electronic signal when the electronic signal matches with the automobile.

10. The automobile according to claim 9, wherein the electronic signal transmitted by the electronic device has a particular code, and when the particular code of the electronic device matches with one or more reference codes stored in the storage device of the automobile, the electronic signal is determined to match with the automobile.

11. The automobile according to claim 7, wherein the verification information comprises a signature, a password, a face image, a fingerprint image, and/or a voice print.

12. The automobile according to claim 7, wherein the control operation comprises unlocking one or more anti-theft equipments of the automobile and starting one or more on-board equipments of the automobile.

13. A non-transitory storage medium having stored thereon instructions that, when executed by a processor, causes the processor to perform an automobile control method, wherein the method comprises:
setting verification means to control an automobile, and storing criterions of the verification means;
establishing a communication between the automobile and an electronic device, and sending a verification message to the electronic device according to the verification means;
receiving verification information from the electronic device, and comparing the received verification information with the criterions of the verification means; and
receiving a control operation from the electronic device upon condition that the received verification information matches with the criterions of the verification mean, and controlling the automobile to perform the control operation.

14. The storage medium according to claim 13, wherein the verification means comprises a signature verification, a password verification, a face verification, a fingerprint verification, and/or a vocal print verification, and the criterions of the verification means comprise a reference signature, a reference password, a reference face image, a reference fingerprint image, and/or a reference voice print.

15. The storage medium according to claim 13, before establishing a communication between the automobile and an electronic device, wherein the method further comprises:
monitoring whether or not an electronic signal exists within a predetermined range of the automobile;
determining whether or not the electronic signal matches with the automobile, and establishing the communication between the automobile and the electronic device which transmits the electronic signal.

16. The storage medium according to claim 15, wherein the electronic signal transmitted by the electronic device has a particular code, and when the particular code of the electronic device matches with one or more reference codes stored in the a storage device of the automobile, the electronic signal is determined to match with the automobile.

17. The storage medium according to claim 13, wherein the verification information comprises a signature, a password, a face image, a fingerprint image, and/or a voice print.

18. The storage medium according to claim 13, wherein the control operation comprises unlocking one or more anti-theft equipments of the automobile and starting one or more on-board equipments of the automobile.
